(19) United States
(12) Patent Application Publication
(10) Pub. No.: US 2013/0168333 A1
(43) Pub. Date: Jul. 4, 2013

(54) CIRCULATION OF PROCESS WATERS IN ENTRAINED-BED GASIFICATION UNDER PROCESS PRESSURE WITH A PRESSURE FILTRATION UNIT

(71) Applicants: Thomas Fleischer, Freiberg (DE); Frank Hannemann, Freiberg (DE); Manfred Schingnitz, Freiberg (DE); Peter Taffelt, Freiberg (DE)

(72) Inventors: Thomas Fleischer, Freiberg (DE); Frank Hannemann, Freiberg (DE); Manfred Schingnitz, Freiberg (DE); Peter Taffelt, Freiberg (DE)

(21) Appl. No.: 13/821,048

(22) PCT Filed: Aug. 16, 2011
(86) PCT No.: PCT/EP11/64108

§ 371 Date: Mar. 6, 2013

(30) Foreign Application Priority Data
Sep. 9, 2010 (DE) 102010040492.6

(51) Int. Cl. C02F 1/00

(52) U.S. Cl. CPC C02F 1/001
USPC 210/805; 210/196; 210/195.1; 210/96.1

(57) ABSTRACT

An apparatus and a method for circulating process waters from plants of dust-pressure or entrained-flow gasification of solid and liquid fuels are provided, wherein process waters are separated from solids or reduced in their solids content by a pressure filtration unit under process pressure and returned to consumer loads, such as raw gas quenching processes and scrubbing processes.

### CROSS REFERENCE TO RELATED APPLICATIONS

This application is the U.S. National Stage of International Application No. PCT/EP2011/064108 filed Aug. 16, 2011, and claims the benefit thereof. The International Application claims the benefits of German Application No. 10 2010 040 492.6 DE filed Sep. 9, 2010. All of the applications are incorporated by reference herein in their entirety.

### FIELD OF INVENTION

The invention relates to an apparatus and a method for controlling the circulation of process waters of an entrained-flow reactor for the gasification of solid and liquid fuels at gasification temperatures up to 1850° C. and process pressures above atmospheric pressure up to 10 MPa.

### BACKGROUND OF INVENTION

The invention relates to a new technology for controlling the circulation of process waters in entrained-flow gasification, wherein solid and liquid fuels are converted by means of a gasification medium containing free oxygen at pressures up to 10 MPa and at temperatures up to 1850° C. into an H₂- and CO-rich raw gas. The technology is described at length in “Die Veredelung und Umwandlung von Kohle” (“Coal processing and conversion”), published by the Deutsche Wissenschaftliche Gesellschaft für Erdöl, Erdgas und Kohle e.V. (German Society for Petroleum and Coal Science and Technology), December 2008, chapter on GSP gasification. According thereto, the raw gas exiting the gasification chamber at temperatures up to 1850° C. is first cooled in a quench chamber through injection of water in excess up to the point of water vapor saturation, which at a gasification pressure of 4 MPa is equivalent to approx. 210° C., and is subsequently freed from entrained particulate matter in scrubbing equipment. The slag accumulates in the water sump of the quench chamber and is discharged together with slag water. The surplus water from the quenching is subjected together with scrubbing waters and accumulating condensates as soot water to a separation of the solids so that it can be returned in the circuit to the quenching and scrubbing process. The raw gas scrubbing and soot water treatment processes are illustrated in FIGS. 4.4.2.4.14 and 4.4.2.4.15 of the above-cited literature.

Thereafter the soot water laden with soot and fine slag is first expanded from process to ambient pressure, has flocculating agents added to it, and is fed to a circular thickener operating at ambient pressure.

The thin phase with low solid content is returned via pumps to the quenching process, and the deposited slurry is dewatered by way of a filter press. The solids are disposed of or returned to the gasification process, and the separated-off water returns to the process together with the thin phase.

The technology described has a number of deficiencies which lead to increased costs and operational outages. One drawback to be singled out in particular is the heavy wear and tear in the expansion valves, in which very high velocities occur in the three-phase-water-gas(steam)-solid-flow as a result of partial evaporation and the removal of dissolved gases from the hot (>200° C.) soot water. The considerable mass of accumulating degassing vapors must be cooled and recycled.

The cleaned waters must be pumped back to process pressure by means of circulation pumps and supplied to the loads.

### SUMMARY OF INVENTION

An object is to develop the quench water circuit for an entrained-flow gasifier in such a way that the wear and tear in the expansion valves is inconsequential, the volume of accumulating degassing vapors is considerably reduced, and virtually no energy is expended in order to raise the clean water to process pressure.

According to the independent claims it is proposed, not to expand the accumulating soot water, but to separate off the solids under pressure, for which purpose special types of equipment such as pressure filters are used. The soot water accumulating during the quenching and scrubbing process of the gasification method is therefore liberated of entrained solids without expansion and returned to the circuit. The solution according to the invention is expansion-free in respect of the process waters circulated in the circuit.

The solution according to the invention saves on the expenditure for replacement of worn expansion valves. The reduction in the amount of accumulating degassing vapors is accompanied by a corresponding reduction in the costs of handling said vapors. The expenditure of energy in order to raise the circulation water to process pressure is eliminated.

Advantageous embodiments are disclosed in the dependent claims

### BRIEF DESCRIPTION OF THE DRAWINGS

The invention is explained below as an exemplary embodiment to an extent necessary for understanding with reference to a figure, in which:

FIG. 1 shows a soot water cleaning process with a pressure filtration unit

### DETAILED DESCRIPTION OF INVENTION

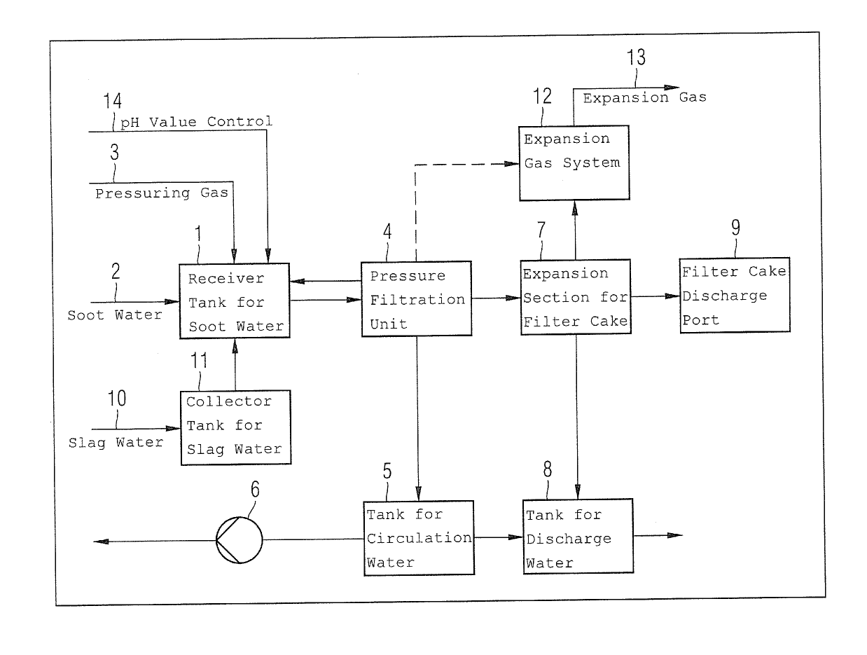

### Example 1 According to FIG. 1

In an entrained-flow gasifier having a gross rated capacity of 500 MW, the gasification of anthracite coal by means of oxygen and steam results in the generation of 120000 Nm³ of raw gas (dry) at a temperature of 1700° C. at 4.2 MPa. The quenching and raw gas scrubbing stages and condensate separators produce 162 t/h of soot water at a temperature of 170° C. and a pressure of 4.2 MPa, said soot water being fed to the soot water receiver tank 1 via the soot water line 2. Pressurizing gas 3 is supplied in order to maintain the pressure at a constant level. The slag water likewise reaches the soot water receiver tank 1 via the line 10 and the collector tank 11 at a volumetric flow rate of 50 t/h and at a temperature of 71° C. From the receiver tank 1, the collected soot water passes into the pressure filtration unit 4 at a volumetric flow rate of 212 t/h and at a temperature of 147° C.

From this, 209 t/h of clean water at 147° C. is recycled as circulation water via the receiver tank 5 and the circulation pump 6 to the loads, such as the quencher for example. The filter slurry from the pressure filtration unit 4 is ducted via the expansion section 7, its volume amounting to 5.3 t/h with a moisture content of 60%. The volume of solids equals 2.1 t/h, the volume of water 3.2 t/h. Accumulating waters from the expansion section 7 are collected in the container 8 and discharged from the process, while the separated-off solids are discharged via the filter cake discharge port 9. The discharged volume of water simultaneously serves for sluicing out salts in order to limit their concentration in the waters to a specified value. This causes the salts introduced with the coal ash to leave the circuit. Should this sluiced-out volume not be sufficient, an additional discharge from the receiver tank 5 for the circulation water can be arranged. In any event the salt load introduced with the coal is removed from the circuit again by discharge of water. The pressure losses in the pressure filtration unit 4 and the expansion section 7 cause small volumes of dissolved gases to expand; these are collected in the expansion gas system 12 and discharged via the expansion gas line 13. They can be supplied to the raw gas or the sour gas of a desulfurization plant for recovery or disposal. In order to avoid deposits in the pipework and containers due to variations in the carbonate/bicarbonate balance, a pH value controller 14 is provided in the soot water receiver tank 1.

With the invention, therefore, particle separation takes place substantially at the pressure level of the gasification reactor.

With the invention, therefore, particle separation takes place substantially under gasification pressure.

The invention also relates to a method for circulating process waters in the entrained-flow gasification of solid and liquid fuels at gasification temperatures up to 1850° C. and pressures up to 10 MPa (100 bar), wherein a quench stage as well as further water-driven cleaning stages are disposed downstream of the gasification process, wherein the soot water formed from the slag water, the residual quench water, scrubbing waters and condensates is liberated from solids under process pressure and returned to the loads in the circuit.

In a special development of the invention a pressure filtration unit is employed for separating solids from the soot water.

In a special development of the invention the soot water is subjected to checking by a pH value controller prior to or after the solids separation stage.

In a special development of the invention the discharging of a specific water volume is used to limit the salt content of the circulation water.

In a special development of the invention the solids deposited as a filter cake are returned together with the fuel to the gasification process.

In a special development of the invention accumulating expansion gases are collected and fed back to the raw gas.

In a special development of the invention accumulating expansion gases are supplied to the sour gas of a sour gas desulfurization plant.

The invention also relates to an apparatus whose circulation configuration includes the following equipment:
collector tank for the soot water formed from different process waters
pressure filtration unit
expansion section for filter cake
receiver tank for circulation water
circulation water pump
sluicing-out device for circulation water
pH value controller for circulation waters

### LIST OF REFERENCE SIGNS

1 Receiver tank for soot water
2 Soot water line
3 Pressuring gas
4 Pressure filtration unit
5 Receiver tank for circulation water
6 Circulation water pump
7 Expansion section for filter cake
8 Collector tank for water to be sluiced out
9 Filter cake discharge port
10 Slag water line
11 Collector tank for slag water
12 Expansion gas system
13 Expansion gas line
14 pH value controller

1.-13. (canceled)

14. An apparatus for circulating process waters of an entrained-flow reactor for a gasification of solid and liquid fuels at gasification temperatures up to 1850° C. and process pressures above atmospheric pressure up to 10 MPa (100 bar), comprising:
a circulation configuration comprising:
a collector tank with a process pressure for soot waters formed from different process waters,
a pressure filtration unit for separating the soot waters into clean water and filter cake under the process pressure, wherein the soot waters are supplied from a collector tank to the pressure filtration unit,
an expansion section for the filter cake, and
a circulation water pump for pumping the clean water, which is subject to the process pressure, to consumer loads of the entrained-flow reactor.

15. The apparatus as claimed in claim 14, further comprising:
a receiver tank for circulation water arranged between the pressure filtration unit and the consumer loads consuming the clean water of the entrained-flow reactor.

16. The apparatus as claimed in claim 14, further comprising:
a sluicing-out device for circulation water.

17. The apparatus as claimed in claim 14, further comprising:
a pH value controller for controlling and/or checking the different process waters.

18. A method for circulating soot water in an entrained-flow gasification of solid and liquid fuels at gasification temperatures up to 1850° C. and process pressures above atmospheric pressure up to 10 MPa (100 bar), comprising:
separating, under process pressure, soot water from an entrained-flow gasifier within a pressure filtration unit into clean water and filter slurry under process pressure,
guiding the filter slurry from the pressure filtration unit via an expansion section, and
supplying the clean water having approximately process pressure to consumer loads of the entrained-flow gasifier.

19. The method as claimed in claim 18, wherein the soot water is selected from the group consisting of soot water from a quencher sump, slag water, soot water from a raw gas scrubbing stage, condensate, and a combination thereof.

20. The method as claimed in claim 18, wherein pressurizing gas is applied to the soot water in order to maintain pressure at a constant level.

21. The method as claimed in claim 18, wherein waters from an expansion section and deposited solids are discharged by way of a filter cake discharge port.

22. The method as claimed in claim 18, wherein the soot water is checked by a pH value controller.

23. The method as claimed in claim 18, wherein a volume of water sluiced out from a water circuit is dimensioned in accordance with a salt content in the water circuit.

24. The method as claimed in claim 21, wherein the deposited solids are supplied together with fuel to the entrained-flow gasifier.

25. The method as claimed in claim 19, wherein accumulating expansion gases are supplied to the raw gas.

26. The method as claimed in claim 18, wherein accumulating expansion gases are supplied to a sour gas of a sour gas desulfurization plant.
